(19) United States
(12) Patent Application Publication
(10) Pub. No.: US 2005/0232314 A1
(43) Pub. Date: Oct. 20, 2005

(54) External oscillation type mode-locking semiconductor laser

(76) Inventor: Yoichi Hashimoto, Tokyo (JP)

Correspondence Address: Paul J Esatto Jr;Scully Scott Murphy & Presser, 400 Garden City Plaza, Garden City, NY, 11530, US

(21) Appl. No.: 10/507,783

(22) PCT Filed: Mar. 7, 2003
(86) PCT No.: PCT/JP03/02694

§ 371 Date: Jun. 16, 2005

(30) Foreign Application Priority Data
Mar. 11, 2002 (JP) 2002-065877

(51) Int. Cl. H01S 3/098

(52) U.S. Cl. 372/18; 372/20

(57) ABSTRACT

An external-cavity mode-locked semiconductor laser includes: a semiconductor laser device including a gain region and a saturable absorption region; a reflecting mirror; and a modulation bias generating circuit for supplying a modulation bias modulated by a microwave to the saturable absorption region. The semiconductor laser device has a reflecting surface and an output surface which faces the reflecting surface. The reflecting mirror is provided to face the output surface such that the reflecting surface and the reflecting mirror constitute a cavity. By using a cavity length L and an effective refractive index n of the cavity, a fundamental mode-locked frequency f_{ML} is defined by the equation: f_{ML}=c/2nL. A frequency of the microwave is M times the fundamental mode-locked frequency f_{ML}. By using an effective refractive index n_{D} of the semiconductor laser device and a device length L_{D}, a frequency f_{D} is defined by the equation: f_{D}=c/2nL. The frequency f_{D} is substantially coincident with the frequency of the microwave.

### TECHNICAL FIELD

The present invention relates to an optical pulse train source, and more particularly to an optical pulse train source using a mode-locked semiconductor laser and generating an optical pulse train with a high repetition frequency.

### BACKGROUND ART

In an optical transmission system used in core optical communications, a transmission rate of 40 Gbit/sec or more is required. In order to attain such a high transmission rate, a light source is necessary which generates optical clock pulses with a high repetition frequency (repetition rate), more specifically, with a repetition frequency of 40 GHz or more. Variable wavelength and repetition frequency and a stable operation are required for an optical clock pulse source.

An external-cavity mode-locked semiconductor laser satisfying such requirements is a promising optical clock pulse source. FIG. 1 is a schematic view showing a conventional typical external-cavity mode-locked semiconductor laser 400. The external-cavity mode-locked semiconductor laser 400 has a semiconductor laser device 404. The semiconductor laser device 404 has a gain region (gain region) 401 and a saturable absorption region (saturable absorption region) 402. An end face of the gain region 401, namely, an output surface 404a of the semiconductor laser device 404 is coated with an anti-reflective film 403. An end face of the saturable absorption region 402, namely, a reflecting surface 404b is preferably coated with a highly-reflective film, and hence the reflecting surface 404b has a high reflectance.

A reflecting mirror 406 is provided so as to face the output surface 404a of the semiconductor laser device 404. In order to generate an optical pulse train 416, a half mirror is used as the reflecting mirror 406. The reflecting mirror 406 and the reflecting surface 404b of the semiconductor laser device 404 function as a Fabry-Perot cavity 407. The reflecting mirror 406 is movable due to a mirror moving mechanism (not shown). Since the reflecting mirror 406 is movable, it is possible to adjust the distance between the reflecting mirror 406 and the reflecting surface 404b, namely, a cavity length L of the cavity 407.

A lens 405 and a wavelength selection device 408 are inserted between the reflecting mirror 406 and the output surface 404a of the semiconductor laser device 404. The lens 405 collimates an optical beam outputted from the output surface 404a of the semiconductor laser device 404. The wavelength selection device 408 selects wavelength of that optical beam. The wavelength selection device 408 is configured so as to make the wavelength of the optical beam variable.

A modulation bias generating circuit 411 is connected to the saturable absorption region 402 of the semiconductor laser device 404. The modulation bias generating circuit 411 includes a reference microwave oscillator 412, a DC bias supply 413 and a bias-T circuit 415. The modulation bias generating circuit 411 modulates a direct current bias generated by the DC bias supply 413 by using microwave generated by the reference microwave oscillator 412, and generates a modulation bias. The modulation bias is supplied to the saturable absorption region 402.

A current source 414 is connected to the gain region 401. The current source 414 supplies a drive current to the gain region 401.

The laser 400 starts oscillating when the drive current is supplied to the gain region 401 and the modulation bias is supplied to the saturable absorption region 402. When the drive current and the modulation bias are supplied, the semiconductor laser device 404 generates light. The generated light bounds back and forth inside the cavity 407 to cause resonance inside the cavity 407. The resonance in the cavity 407 generates an optical pulse train inside the cavity 407. The optical pulse train partially transmits through the reflecting mirror 406, and the optical pulse train 416 is outputted from the reflecting mirror 406.

The repetition frequency of the optical pulse train 416 is coincident with a fundamental mode-locked frequency defined by the following equation:
f_{ML}=c/2nL (1)

Here, the c is the velocity of light, the n is an effective refractive index of the cavity 407, and the L is the cavity length.

The frequency of the microwave used for the modulation is coincident with the fundamental mode-locked frequency f_{ML}. Since the microwave with the same frequency as the fundamental mode-locked frequency f_{ML} is used for the modulation, it is possible to match the repetition frequency of the optical pulse train 416 stably to the fundamental mode-locked frequency F_{ML}, and to synchronize the optical pulse train 416 with an external circuit. Such an operation is referred to as a fundamental mode-locked operation.

As can be understood from the equation (1), the repetition frequency of the optical pulse train 416 obtained by the fundamental mode-locked operation can be made higher by shortening the cavity length L. However, the lens 405 and wavelength selection device 408 inserted into the cavity 407 prevents the shortening of the cavity length L physically, and hence prevents enhancement of the repetition frequency of the optical pulse train 416. The maximum repetition frequency of the optical pulse train 416 obtained by the fundamental mode-locked operation is typically 10 to 20 GHz. It is difficult to attain a repetition frequency exceeding 40 GHz required in a recent optical transmission system by using the fundamental mode-locked operation.

Proposed in order to make the repetition frequency higher is a harmonic mode-locked operation which generates a modulation bias supplied to the saturable absorption region 402 by modulating a direct current bias by using a microwave with a frequency equal to integer multiples of the fundamental mode-locked frequency f_{ML}. The harmonic mode-locked operation enables the generation of an optical pulse train with a repetition frequency of f_{ML}*M. Here, the M is an integer.

One problem of the high-frequency mode-locked operation is that a sub pulse train having a repetition frequency different from a desirable repetition frequency and substantial optical power is generated and is mixed in the optical pulse train 416 outputted.

The occurrence of the sub pulse train results from imperfection of the anti-reflective film 403 provided on the output surface 404a of the semiconductor laser device 404. Due to the imperfection of the anti-reflective film 403, the output surface 404a and reflecting surface 404b of the semiconductor laser device 404 constitute an undesirable sub-cavity. Because of this sub-cavity, generated in the semiconductor laser device 404 is the sub pulse train with a repetition frequency f_{D} defined by the following equation:
f_{D}=c/2n_{D}L_{D} (2)

Here, the n_{D} is a refractive index of the semiconductor laser device 404, and the L_{D} is a distance between the output surface 404a and the reflecting surface 404b, namely, the cavity length of the sub-cavity.

In the fundamental mode-locked operation, the optical power of this sub pulse train is relatively small, which does not bring about any problem. In the harmonic mode-locked operation, however, the enhancement of the gain in the gain region 401 is necessary for the sake of its stabilization, and the high gain in the gain region 401 also increases the optical power of sub pulses, which exposes the problem of contamination of the sub pulse train.

An optical pulse source for generating an optical pulse whose deformation is limited by using appropriate wavelength and repetition frequency is disclosed in Japanese Laid Open Patent Application (JP-A-Heisei 6-291423). However, this document does not point out the problem of the generation of the undesirable sub pulse train.

### DISCLOSURE OF INVENTION

It is therefore an object of the present invention to provide an external-cavity mode-locked semiconductor laser which can generate by a high-frequency mode-locked operation an optical pulse train from which a sub pulse train with a repetition frequency different from a desirable repetition frequency is eliminated.

In an aspect of the present invention, an external-cavity mode-locked semiconductor laser includes: a semiconductor laser device including a gain region and a saturable absorption region; a reflecting mirror; and a modulation bias generating circuit for supplying a modulation bias modulated by a microwave to the saturable absorption region. The semiconductor laser device has: an output surface coated with an anti-reflective film and configured for outputting an optical pulse train from the semiconductor laser device; and a reflecting surface configured for facing the output surface. The reflecting mirror is provided so as to face the output surface such that the reflecting surface and the reflecting mirror constitute a cavity. By using a cavity length L, which is a distance between the reflecting surface and the reflecting mirror, and an effective refractive index n of the cavity, a fundamental mode-locked frequency f_{ML} is defined by the following equation: f_{ML}=c/2nL. A frequency of the microwave is M times the fundamental mode-locked frequency f_{ML}, wherein the M is an integer equal to or more than 2. A frequency f_{D}, which is defined by using an effective refractive index n_{D} of the semiconductor laser device and a device length L_{D} that is a distance between the reflecting surface and the output surface as the following equation: f_{D}=c/2nL, is substantially coincident with the frequency of the microwave. Such an external-cavity mode-locked semiconductor laser substantially matches a timing of a sub pulse with a timing of a main pulse. Thus, the external-cavity mode-locked semiconductor laser can effectively eliminate the sub pulse having an undesirable repetition frequency from the optical pulse train outputted.

The external-cavity mode-locked semiconductor laser preferably further includes: a wavelength selection device which is inserted between the output surface and the reflecting mirror, and is configured for selectively transmitting a light having a predetermined wavelength; and a lens which is inserted between the wavelength selection device and the output surface, and is configured for collimating the optical pulse train outputted from the output surface. The wavelength selection device makes a wavelength of the optical pulse train outputted by the external-cavity mode-locked semiconductor laser variable.

The external-cavity mode-locked semiconductor laser preferably further includes an adjusting mechanism configured for adjusting the cavity length L by moving the reflecting mirror.

The semiconductor laser device preferably has a passive waveguide in addition to the gain region and the saturable absorption region. The insertion of the passive waveguide makes it easy to set lengths of the gain region and the saturable absorption region such that the chirping which respective of the gain region and the saturable absorption region give to the optical pulse train is cancelled.

The semiconductor laser device preferably further includes an optical path length adjusting region configured for adjusting the effective refractive index n_{D} of the semiconductor laser device. The optical path length adjusting region preferably exhibits an electro-optical effect and includes a waveguide layer for guiding the optical pulse train. A refractive index of the waveguide layer varies in response to a current or a bias voltage supplied to the optical path length adjusting region. This makes it easy to match the frequency f_{D} precisely with the frequency of the microwave.

### BRIEF DESCRIPTION OF DRAWINGS

FIG. 1 shows a typical conventional external-cavity mode-locked semiconductor laser;

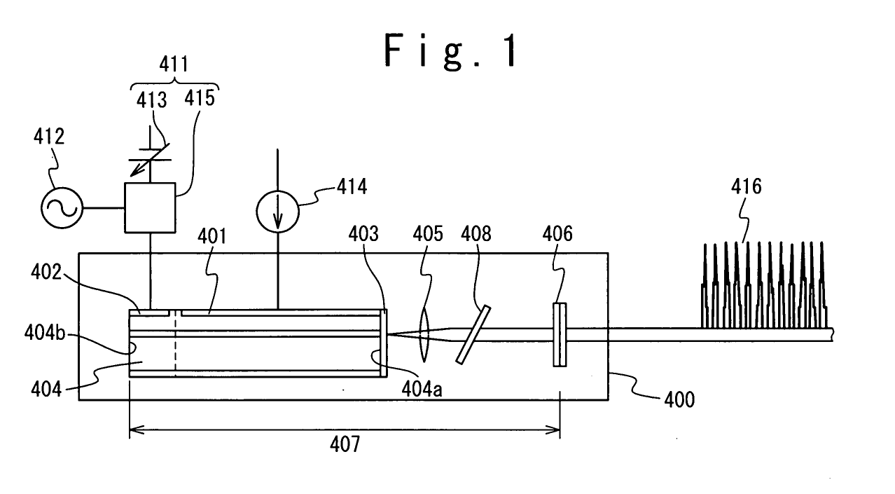

FIG. 2 shows an external-cavity mode-locked semiconductor laser according to a first embodiment of the present invention;

FIG. 3 is a view showing a mechanism that prevents contamination of a sub pulse having an undesirable repetition frequency;

FIG. 4 shows an external-cavity mode-locked semiconductor laser according to the first embodiment of the present invention; and

FIG. 5 shows an external-cavity mode-locked semiconductor laser according to the first embodiment of the present invention.

### BEST MODE FOR CARRYING OUT THE INVENTION

Embodiments of an external-cavity mode-locked semiconductor laser according to the present invention will be described below with reference to the attached drawings.

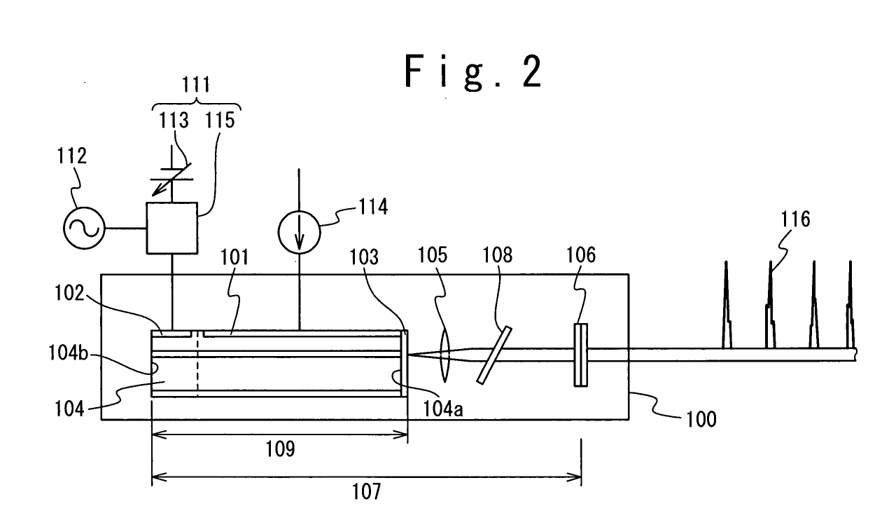

FIG. 2 is a block diagram of an external-cavity mode-locked semiconductor laser 100 in a first embodiment of the present invention. The external-cavity mode-locked semiconductor laser 100 has a semiconductor laser device 104. The semiconductor laser device 104 has a gain region 101 in its front edge side and a saturable absorption region 102 in its rear edge side. An end face of the gain region 101, namely, an output surface 104a of the semiconductor laser device 104 is coated with an anti-reflective film 103. An end face of the saturable absorption region 102, namely, a reflecting surface 104b of the semiconductor laser device 104 is preferably coated with a highly-reflective film (not shown).

A reflecting mirror 106 is provided so as to face the output surface 104a of the semiconductor laser device 104. A half mirror is used as the reflecting mirror 106. A Fabry-Perot cavity 107 is formed between the reflecting mirror 106 and the reflecting surface 104b of the semiconductor laser device 104. The reflecting mirror 106 is movable due to a mirror moving mechanism (not shown). Since the reflecting mirror 106 is movable, it is possible to adjust the distance between the reflecting mirror 106 and the reflecting surface 104b, namely, a cavity length L of the cavity 107.

A lens 105 and a wavelength selection device 108 are inserted between the reflecting mirror 106 the output surface 104a of the semiconductor laser device 104. The lens 105 collimates an optical pulse outputted from the output surface 104a of the semiconductor laser device 104. The wavelength selection device 108 selectively transmits a light with a predetermined wavelength. The wavelength of the light transmitted by the wavelength selection device 108 is variable. Thus, the wavelength selection device 108 makes the wavelength of the optical pulse adjustable.

A modulation bias generating circuit 111 is connected to the saturable absorption region 102 of the semiconductor laser device 104. The modulation bias generating circuit 111 includes a reference microwave oscillator 112, a DC bias supply 113 and a bias-T circuit 115. The modulation bias generating circuit 111 modulates a direct current bias generated by the DC bias supply 113 by using microwave generated by the reference microwave oscillator 112, and generates a modulation bias. The modulation bias is supplied to the saturable absorption region 102.

The frequency of the microwave used for the modulation is M times a fundamental mode-locked frequency f_{ML}. Here, the M is an integer. By using the cavity length L of the cavity 107, the fundamental mode-locked frequency f_{ML} is defined by the following equation:
f_{ML}=c/2nL (3)

A current source 114 is connected to the gain region 101. The current source 114 supplies a drive current to the gain region 101. The larger the drive current supplied to the gain region 101 becomes, the higher the gain in the gain region 111 becomes.

The distance between the output surface 104a and the reflecting surface 104b of the semiconductor laser device 104, namely, a device length of the semiconductor laser device 104 is adjusted so as to be substantially coincident with L_{D} which is defined by the following equation:
L_{D}=c/(2n_{D}Mf_{ML}) (4)

By using the equation (3), the equation (4) can be re-written as follows:
L_{D}=nL/(n_{D}M) (5)

The equation (4) is equivalent to that an optical path length 2n_{D}L_{D} for which the optical pulse train propagates inside the semiconductor laser device 104 is coincident with c/(Mf_{ML}).

The laser 100 starts oscillating when the drive current is supplied to the gain region 101 and the modulation bias is supplied to the saturable absorption region 102. When the drive current and the modulation bias are supplied, the semiconductor laser device 104 generates light. The generated light bounds back and forth inside the cavity 107 to cause resonance inside the cavity 107. Due to the resonance in the cavity 107, a main pulse train is generated inside the cavity 107. The repetition frequency of the main pulse train is substantially coincident with the frequency of the microwave used for the modulation, and is M times the fundamental mode-locked frequency f_{ML} The main pulse train generated inside the cavity 107 partially transmits through the reflecting mirror 106, and an optical pulse train 116 with a desirable repetition frequency f_{ML}*M is outputted from the reflecting mirror 106.

The imperfection of the anti-reflective film 103 can cause the semiconductor laser device 404 to function in isolation as an undesirable sub-cavity. This undesirable sub-cavity may generate a sub pulse train inside the cavity 107. A repetition frequency f_{D} of the possible sub pulse train is obtained from the following equation:
f_{D}=c/2n_{D}L_{D} (6)

However, by substituting the equation (4) into the equation (6), the following equation is obtained:
f_{D}=f_{ML}*M (7)

As can be understood from this equation, the repetition frequency f_{D} of the sub pulse train is substantially coincident with the repetition frequency f_{ML}*M of the main pulse train generated inside the cavity 107. This means that a sub pulse occurs substantially simultaneously with a main pulse, and hence an optical pulse train with the undesirable repetition frequency is eliminated from the optical pulse train generated inside the cavity 107. Consequently, this prevents contamination of the sub pulse with the undesirable repetition frequency into the optical pulse train 116 outputted.

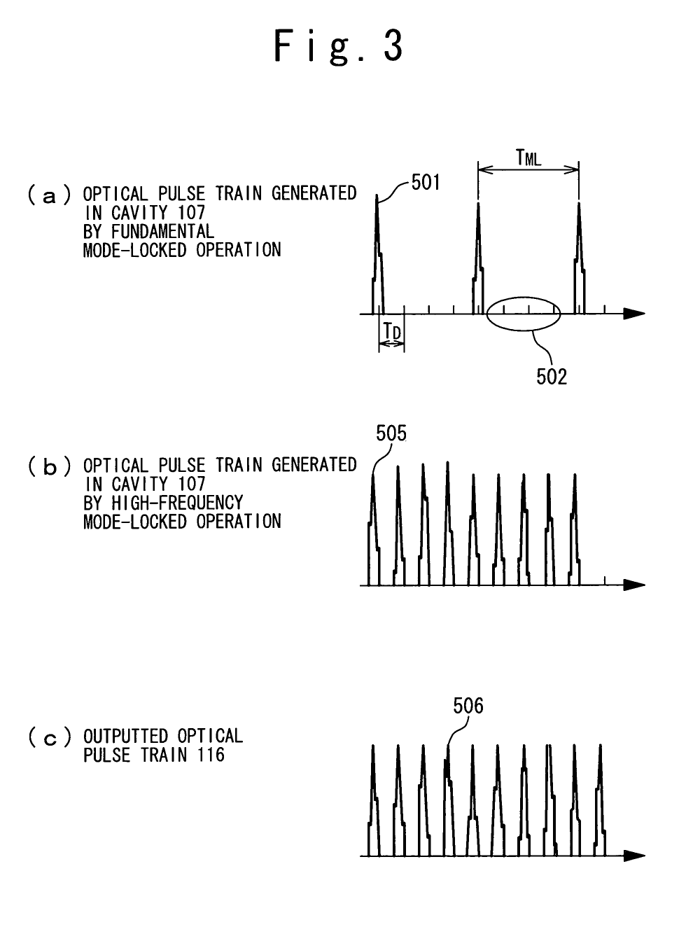

FIG. 3 is a view for explaining the suppression of the contamination of the sub pulse. When the optical pulse train is generated by the fundamental mode-locked operation in the external-cavity mode-locked semiconductor laser 100, main pulses 501 having the repetition frequency f_{ML}, namely, a period T_{ML}(=1/f_{ML}) are generated as shown in FIG. 3(a). At the same time, due to the imperfection of the anti-reflective film 103, sub pulses 502 having the repetition frequency f_{D}(=c/2n_{D}L_{D}), namely, a period T_{D}(=1/f_{D}) are generated. When starting the harmonic mode-locked operation in the external-cavity mode-locked semiconductor laser 100 by increasing the current supplied to the gain region 101 and further supplying the modulated bias modulated through the microwave with the frequency of f_{ML}*M to the saturable absorption region 102, main pulses 505 with the repetition frequency f_{ML}*M are generated as shown in FIG. 3(b). As can be understood from the equation (7), the repetition frequency f_{D} of the sub pulse 502 is coincident with the repetition frequency F_{ML}*M of the main pulse 505. Therefore, the sub pulse 502 and the main pulse 505 are generated substantially simultaneously. Thus, the sub pulse is apparently eliminated from the optical pulse train propagating inside the cavity 107. Therefore, as shown in FIG. 3(c), the sub pulse with the undesirable repetition frequency is eliminated from the optical pulse train 116 generated from the cavity 107.

As mentioned above, the device length L_{D} defined to satisfy the equation (3) enables the generation of the optical pulse train 116 from which the sub pulse train having the undesirable repetition frequency is eliminated.

An example of the harmonic mode-locked operation will be described below in detail. In this example, the external-cavity mode-locked semiconductor laser having the fundamental mode frequency f_{ML} of 10 GHz carries out the harmonic mode-locked operation to generate the optical pulse train with the repetition frequency of 40 GHz. When the refractive index of the semiconductor laser device 404 is 3.6, the optical pulse train 116 having the repetition frequency of 40 GHz can be obtained by setting the device length L_{D} to 1040 □m. The device length L_{D} has an error resulting from inaccuracy of cleavage. The error of the device length L_{D} is typically up to 10 □m. If the device length L_{D} has an error of 10 □m, a difference of 0.5 GHz is caused between the repetition frequency of the main pulse train and that of the sub pulse train. This implies that there is a difference of 0.25 ps between the timing of the main pulse and that of the sub pulse. Since the pulse width of the main pulse is normally 1 ps or more, the sub pulse generated at the timing that is different by 0.25 ps is included in the main pulse. The difference of 0.25 ps is equivalent to that there is no undesirable sub pulse.

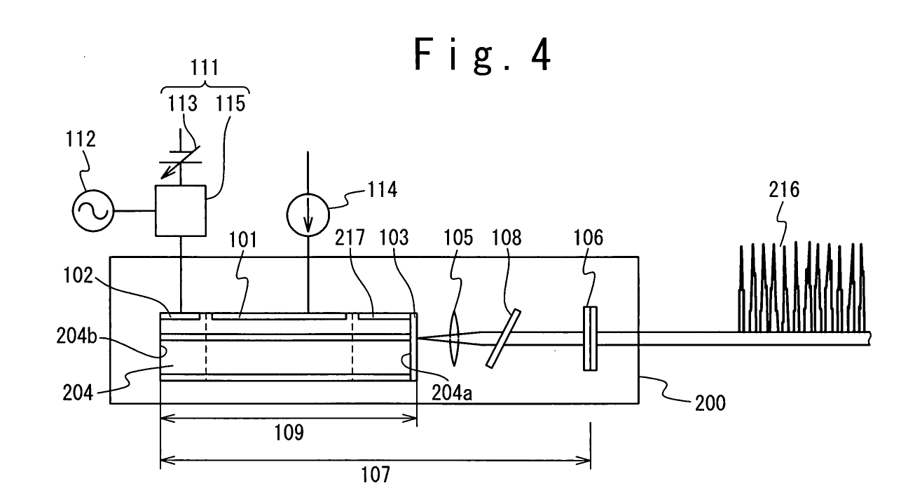

FIG. 4 is a block diagram showing an external-cavity mode-locked semiconductor laser according to a second embodiment of the present invention. The same reference numbers are given to the same components shown in FIG. 2 and FIG. 4, and their detailed explanations will be omitted.

An external-cavity mode-locked semiconductor laser 200 in the present embodiment has a semiconductor laser device 204 including a passive waveguide 217 in addition to the gain region 101 and the saturable absorption region 102. The gain region 101 is connected to the saturable absorption region 102, and the passive waveguide 217 is connected to the gain region 101 on the opposite side to the saturable absorption region 102. An end face of the passive waveguide 217 is used as an output surface 204a of the semiconductor laser device 204, and the end face of the saturable absorption region 102 is used as a reflecting surface 204b. The output surface 204a is coated with the anti-reflective film 103. The reflecting surface 204b of the semiconductor laser device 204 is preferably coated with a highly-reflective film.

The operation of the laser 200 in the second embodiment is similar to that of the laser 100 in the first embodiment. The laser 200 starts oscillating when the drive current is supplied to the gain region 101 and the modulation bias is supplied to the saturable absorption region 102. When the drive current and the modulation bias are supplied, the semiconductor laser device 104 generates light. The generated light bounds back and forth inside the cavity 107 to cause resonance inside the cavity 107. Due to the resonance in the cavity 107, a main pulse train is generated inside the cavity 107. The repetition frequency of the main pulse train is coincident with the frequency of the microwave used for the modulation, and is M times the fundamental mode-locked frequency f_{ML}. The main pulse train generated inside the cavity 107 partially transmits through the reflecting mirror 106, and an optical pulse train 116 with a desirable repetition frequency f_{ML}*M is outputted from the reflecting mirror 106. As mentioned above, the repetition frequency f_{D} of the possible sub pulse train is coincident with the frequency of the microwave used for the modulation, which prevents the contamination of the sub pulse train with an undesirable repetition frequency into the optical pulse train 116.

The passive waveguide 217 makes it easy to adjust the lengths of the gain region 101 and the saturable absorption region 102 such that the chirping of the optical pulse train does not occur, with keeping the device length L_{D} of the semiconductor laser device 204 (namely, the distance between the output surface 204a and the reflecting surface 204b) to satisfy the relationship indicated by the equation (3). When the optical pulse train propagating inside the cavity 107 passes through the gain region 101 and the saturable absorption region 102, its wavelength varies due to the chirping. The variation of the wavelength due to the chirping in the gain region 101 is opposite to that in the saturable absorption region 102. Therefore, it is necessary to optimally select the lengths of the gain region 101 and the saturable absorption region 102 so as to cancel the chirping in the gain region 101 and the saturable absorption region 102. However, according to the semiconductor laser device 104 without the passive waveguide 217 in the first embodiment, the lengths of the gain region 101 and the saturable absorption region 102 are constrained by the requirement that the device length L_{D} should satisfy the relationship indicated by the equation (3). The insertion of the passive waveguide 217 into the semiconductor laser device 204 eases this constraint and makes it easy to adjust the lengths of the gain region 101 and the saturable absorption region 102 such that the optical pulse train 116 without any chirping can be obtained.

A concrete example of the semiconductor laser device 204 will be described below. The passive waveguide 217 is formed with an active layer which is configured to transmit a light having a wavelength near 1550 nm. In order to generate an optical pulse train having a repetition frequency of 40 GHz while eliminating sub pulses by means of the harmonic mode-locked operation, it is necessary to set the device length L_{D} of the semiconductor laser device 204 to 1040 □m. This device length L_{D} includes a length of the gain region 201 and a length of the saturable absorption region 202. It is known from experiences that when the length of the saturable absorption region 202 is 40 □m, the chirping can be removed by setting the length of the gain region 201 to 500 □m. Therefore, when the length of the saturable absorption region 202 is 40 □m and the device length L_{D} is adjusted to 1040 □m by setting the length of the gain region 201 to 1000 □m, the chirping is caused in the optical pulse train 116. The insertion of the passive waveguide 217 having a length of 500 □m makes it possible to keep the device length L_{D} 1040 □m and to remove the chirping by setting the length of the gain region 201 to 500 □m.

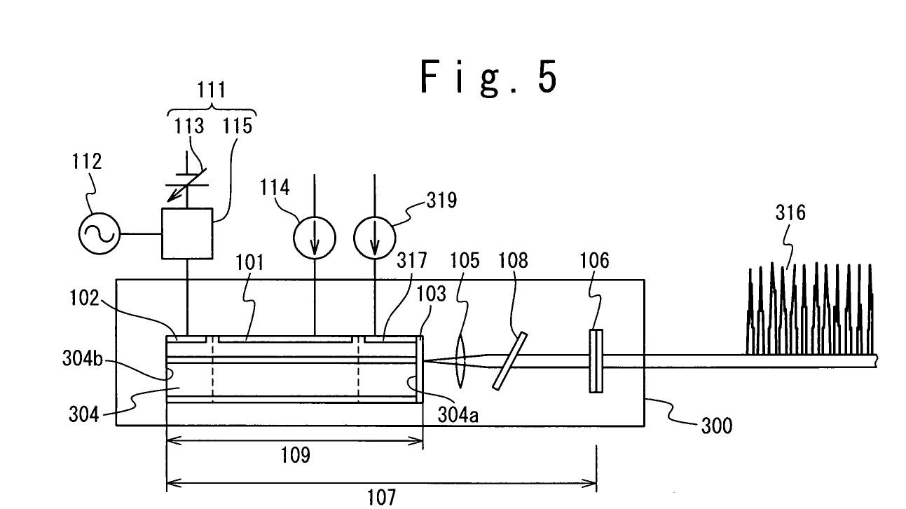

FIG. 5 is a schematic diagram showing an external-cavity mode-locked semiconductor laser according to a third embodiment of the present invention. The same reference numbers are given to the same components shown in FIG. 2 and FIG. 5, and their detailed explanations will be omitted.

An external-cavity mode-locked semiconductor laser 300 in the present embodiment has a semiconductor laser device 304 including an optical length variable region 317 in addition to the gain region 101 and the saturable absorption region 102. The gain region 101 is connected to the saturable absorption region 102, and the optical length variable region 317 is connected to the gain region 101 on the opposite side to the saturable absorption region 102. An end face of the optical length variable region 317 is used as an output surface 304a of the semiconductor laser device 304, and the end face of the saturable absorption region 102 is used as a reflecting surface 304b. The output surface 304a is coated with the anti-reflective film 103. The reflecting surface 304b of the semiconductor laser device 304 is preferably coated with the highly-reflective film.

The optical length variable region 317 includes a waveguide layer having the composition which is different from the active layer of the gain region 101 and does not absorb the wavelength near 1550 nm. The waveguide layer guides the optical pulse train propagating inside the semiconductor laser 304. The optical length variable region 317 is connected to a controller 319. The controller 319 supplies a current or applies a bias voltage to the optical length variable region 317.

Due to the electro-optical effect, a refractive index of the waveguide layer of the optical length variable region 317 varies in response to the current or the bias voltage applied to the optical length variable region 317. Thus, the optical length variable region 317 makes the effective refractive index n_{D} of the entire semiconductor laser device 304 variable. As described in the equation (5), the repetition frequency f_{D} of the sub pulse train generated by the oscillation inside the semiconductor laser device 300 depends on the effective refractive index n_{D}. Thus, the repetition frequency f_{D} of the sub pulse train can be adjusted by the current or the bias voltage applied to the optical length variable region 317.

The current or the bias voltage applied to the optical length variable region 317 is adjusted such that the repetition frequency f_{D} of the possible sub pulse train is coincident with the frequency f_{ML}*M of the microwave used for the modulation. This is equivalent to that the effective refractive index n_{D} of the semiconductor laser device 304 is adjusted such that the device length L_{D} satisfies the equation (4).

The operation of the laser 300 in the third embodiment is similar to that of the laser 100 in the first embodiment. The laser 300 starts oscillating when the drive current is supplied to the gain region 101 and the modulation bias is supplied to the saturable absorption region 102. When the drive current and the modulation bias are supplied, the semiconductor laser device 104 generates light. The generated light bounds back and forth inside the cavity 107 to cause resonance inside the cavity 107. Due to the resonance in the cavity 107, a main pulse train is generated inside the cavity 107. The repetition frequency of the main pulse train is coincident with the frequency of the microwave used for the modulation, and is M times the fundamental mode-locked frequency f_{ML}. The main pulse train generated inside the cavity 107 partially transmits through the reflecting mirror 106, and an optical pulse train 116 with a desirable repetition frequency f_{ML}*M is outputted from the reflecting mirror 106.

The effective refractive index n_{D} of the semiconductor laser device 304 is adjusted by the optical length variable region 317, which can match the repetition frequency f_{D} of the possible sub pulse train with the frequency f_{ML}*M of the microwave used for the modulation. Consequently, the contamination of the sub pulse train with an undesirable repetition frequency into the optical pulse train 116 is prevented. Adjusting the effective refractive index n_{D} of the semiconductor laser device 304 on the basis of an electrical signal makes it possible to match the repetition frequency f_{D} of the sub pulse train precisely with the frequency f_{ML}*M of the microwave used for the modulation, which is preferable.

1. An external-cavity mode-locked semiconductor laser comprising:
a semiconductor laser device including a gain region and a saturable absorption region;
a reflecting mirror; and
a modulation bias generating circuit configured for supplying a modulation bias modulated by a microwave to said saturable absorption region,
wherein said semiconductor laser device has:
an output surface coated with an anti-reflective film and configured for outputting an optical pulse train from said semiconductor laser device; and
a reflecting surface configured for facing said output surface,
wherein said reflecting mirror is provided so as to face said output surface such that said reflecting surface and said reflecting mirror constitute a cavity,
a fundamental mode-locked frequency f_{ML} is defined by the following equation: f_{ML}=c/2nL, by using a cavity length L, which is a distance between said reflecting surface and said reflecting mirror, and an effective refractive index n of said cavity,
a frequency of said microwave is M times the fundamental mode-locked frequency f_{ML}, said M being an integer equal to or more than 2, and
a frequency f_{D}, which is defined by using an effective refractive index n_{D} of said semiconductor laser device and a device length L_{D} being a distance between said reflecting surface and said output surface as the following equation: f_{D}=c/2n_{D}L_{D}, is substantially coincident with said frequency of said microwave.

2. The external-cavity mode-locked semiconductor laser according to claim 1, further comprising:
a wavelength selection device inserted between said output surface and said reflecting mirror, and configured for selectively transmitting a light with a predetermined wavelength; and
a lens inserted between said wavelength selection device and said output surface, and configured for collimating said optical pulse train outputted from said output surface.

3. The external-cavity mode-locked semiconductor laser according to claim 1, further comprising an adjusting mechanism configured for adjusting said cavity length L by moving said reflecting mirror.

4. The external-cavity mode-locked semiconductor laser according to claim 1, wherein said semiconductor laser device further includes a passive waveguide.

5. The external-cavity mode-locked semiconductor laser according to claim 4, wherein lengths of said gain region and said saturable absorption region are set such that chirping which respective of said gain region and said saturable absorption region give to said optical pulse train is cancelled.

6. The external-cavity mode-locked semiconductor laser according to claim 1, wherein said semiconductor laser device further includes an optical path length adjusting region configured for adjusting said effective refractive index n_{D} of said semiconductor laser device.

7. The external-cavity mode-locked semiconductor laser according to claim 6,
wherein said optical path length adjusting region exhibits an electro-optical effect and includes a wavelength layer for guiding said optical pulse train, and
a refractive index of said wavelength layer varies in response to a current or a bias voltage supplied to said optical path length adjusting region.
